(19) United States
(12) Patent Application Publication
(10) Pub. No.: US 2011/0063435 A1
(43) Pub. Date: Mar. 17, 2011

(54) POSITION MEASURING TARGET, POSITION MEASUREMENT SYSTEM, CALCULATION DEVICE FOR POSITION MEASUREMENT AND COMPUTER-READABLE MEDIUM

(75) Inventor: YASUJI SEKO, EBINA-SHI (JP)

(73) Assignee: FUJI XEROX CO., LTD., TOKYO (JP)

(21) Appl. No.: 12/749,813

(22) Filed: Mar. 30, 2010

(30) Foreign Application Priority Data
Sep. 11, 2009 (JP) 2009-210730

(51) Int. Cl. H04N 7/18; G01B 11/14; G06K 9/00

(52) U.S. Cl. 348/135; 356/620; 382/103; 348/E07.085

(57) ABSTRACT

A position measuring target includes four or more reference points and a plurality of shading pattern portions. The four or more reference points are defined on a plane. The references points have positional relationships among them. The plurality of shading pattern portions corresponds a plurality of geometric curved surfaces in relation to the degree of shading used for defining the reference points.

### CROSS-REFERENCE TO RELATED APPLICATION

This application is based on and claims priority under 35 USC 119 from Japanese Patent Application No. 2009-210730 filed on Sep. 11, 2009.

### BACKGROUND

1. Technical Field

The present invention relates to a position measuring target, a position measurement system, a calculation device for position measurement, and a computer-readable medium.

2. Related Art

Various technologies have been proposed as means for measuring the three-dimensional position of an object.

### SUMMARY

According to an aspect of the invention, a position measuring target includes four or more reference points and a plurality of shading pattern portions. The four or more reference points are defined on a plane. The references points have positional relationships among them. The plurality of shading pattern portions corresponds a plurality of geometric curved surfaces in relation to the degree of shading used for defining the reference points.

### BRIEF DESCRIPTION OF THE DRAWINGS

Exemplary embodiments of the invention will be described in detail based on the following figures, wherein:

FIG. 1 is a diagram representing a position measurement system according to an embodiment of the present invention;

FIG. 2A is a diagram representing a position measuring target according to an embodiment of the present invention;

FIG. 2B is a diagram representing the degree of shading of a path denoted by X-Y shown in FIG. 2A;

FIG. 2C is a diagram representing image positions and the degree of shading of a picked-up image;

FIG. 2D is a diagram representing a geometric curved surface in a three-dimensional space which is denoted by the image positions and the degree of shading of a picked-up image;

FIGS. 3A and 3B are diagrams representing an example of a method of defining a reference point for position measurement;

FIG. 4 is a block diagram representing a configuration example of a calculation device shown in FIG. 1;

FIG. 5 is a flowchart representing an example of a process that is performed by a computer;

FIG. 6 is a diagram illustrating an example of a method of calculating a three-dimensional position of an object that has four reference points;

FIG. 7A is a diagram of a position measuring target according to another embodiment of the present invention;

FIG. 7B is a diagram representing the degree of shading of a path denoted by X-Y shown in FIG. 7A;

FIG. 8A is a diagram of a position measuring target according to another embodiment of the present invention;

FIG. 8B is a diagram representing the degree of shading of a path denoted by X-Y shown in FIG. 8A;

FIG. 9A is a diagram of a position measuring target according to another embodiment of the present invention;

FIG. 9B is a diagram representing the degree of shading of a path denoted by X-Y shown in FIG. 9A;

FIG. 10 is a diagram of a position measuring target according to another embodiment of the present invention;

FIG. 11 is a diagram of a position measuring target according to another embodiment of the present invention; and

FIGS. 12A and 12B are diagrams of position measuring targets according to other embodiments of the present invention.

### DETAILED DESCRIPTION

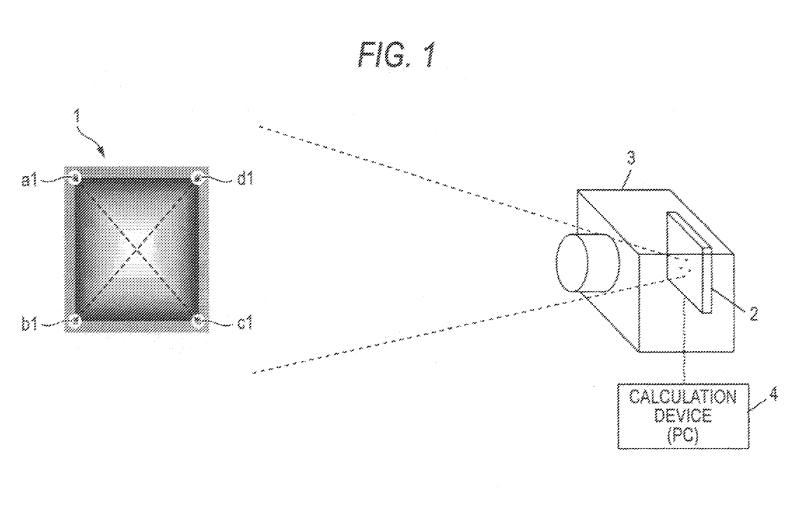

FIG. 1 is a diagram representing a position measurement system according to an embodiment of the present invention. This system, as shown in the figure, includes: a position measuring target 1 that has a plurality of shading pattern portions forming a geometric curved surface in relation to the degree of shading used for defining four reference points a1, b1, c1, and dl; an image pickup device 3 that has a two-dimensional image pickup element 2 that picks up an image of the position measuring target 1; and a calculation device 4 that calculates four reference points a1, b1, c1, and d1 based on the image of the image measuring target 1 that is picked up by the image pickup device 3 and calculates at least one of a three-dimensional position or an angle of the position measuring target 1 based on the calculated reference points. The reference points a1, b1, c1, and d1 have the function of measurement markers that are used for measuring the three-dimensional position of the position measuring target 1.

Here, as the image pickup device 3, a digital camera in which a two-dimensional image pickup element 2 such as a CCD or a CMOS sensor is built is used. However, the image pickup device 3 is not limited thereto. The calculation device 4 is connected to communication means, not shown in the figure, of the image pickup device 3 in a wireless or wired manner for communicating with the image pickup device 3. As the calculation device 4, a computer such as a personal computer (PC) is used. However, the calculation device 4 is not limited thereto. In the example represented in FIG. 1, the number of the reference points is four. However, the number of the reference points may be five or more. This applies the same to examples described below. The configuration of the position measuring target 1 will be described in detail as below. A method of calculating the reference points by using a picked up image and a method of calculating the three-dimensional position or the angle of the target will be described later.

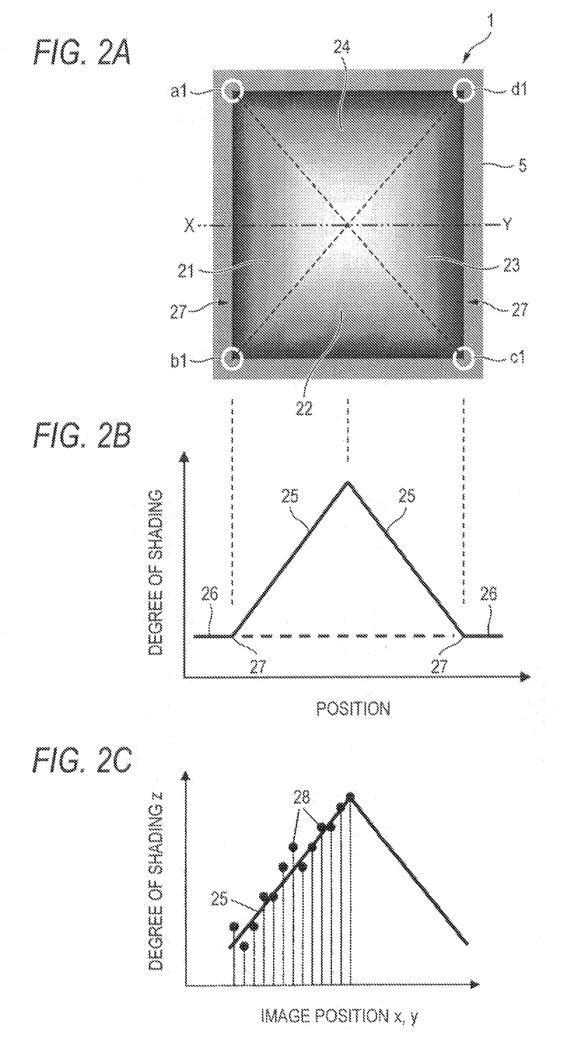

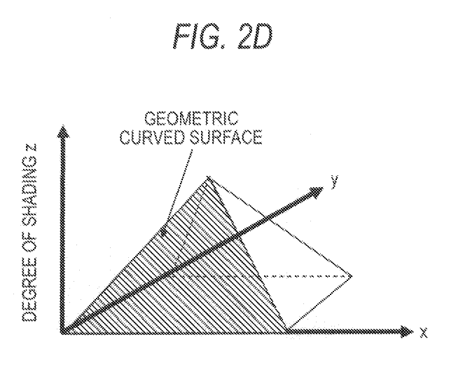

FIG. 2A is a diagram representing a position measuring target according to an embodiment of the present invention. FIG. 2B is a diagram representing the degree of shading of a path denoted by X-Y shown in FIG. 2A. FIG. 2C is a diagram representing the image position and the degree of shading of a picked-up image. As represented in FIG. 2A, the position measuring target 1 includes an object 5 having four or more reference points a1, b1, c1, and d1 of which the positional relationship defined on a plane is known and a plurality of shading pattern portions 21 to 24 that form a geometric curved surface in relation to the degree of shading used for defining the reference points. As the object 5, a plate-shaped member such as a card or a substrate can be used. However, the object 5 is not limited thereto. Here, the geometric curved surface includes a planar surface as a special case of the curved surface. In this example, as represented in FIG. 2B, the degrees of shading of the shading pattern portions 21 to 24 form a planar surface 25. Accordingly, a plurality of intersection lines 27 are formed between the planar surface 25 of the shading pattern portions and the planar surface 26 of the object 5. Here, the intersection line includes an extended line thereof. This applies the same to examples described below. At points in which the intersection lines 27 cross, the reference points a1, b1, c1, and d1 for position measurement are defined. The reason for this will be described as below.

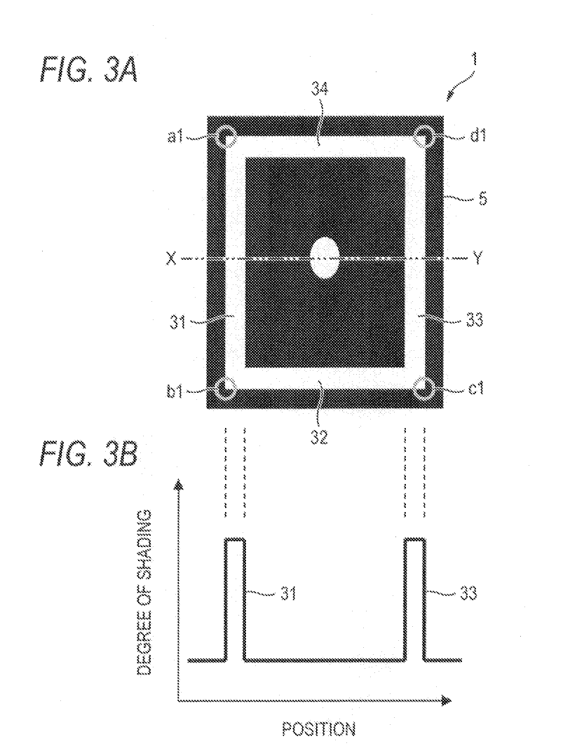

For example, the position measuring target 1 such as a pattern card having plural shading pattern portion is picked up by a camera as an example of the image pickup device 3. The calculation device 4 obtains image information of the pattern card based on a imaging signal picked up by the camera. Then, the calculation device 4 extracts characteristic points based on the image information of the pattern card, and defines the characteristic points as reference points for position measurement. For extracting the characteristic points, for example, the angle, the center of a circle, an intersection of straight lines or curves, or the like of a target is corresponded. FIG. 3A is a diagram representing an example of this case. FIG. 3B is a diagram representing the degree of shading of a path denoted by X-Y shown in FIG. 3A. In the example represented in FIG. 3, the reference points a1, b1, c1, and d1 are extracted at the intersections of straight lines 31 to 34. In this method, edge information of the image information is used. Edge information includes a position in which the intensity of the image level rapidly changes, and the position can be easily influenced by image noise.

Consequently, the image information including the degree of shading is used. The image information including the degree of shading is obtained from a position measuring target portion which has the plural shading pattern portions. The characteristic points are extracted by using the image information including the degree of shading, and the extracted characteristic points are set as the reference points for position measurement. Since the amount of information is large on the entire image planar surface or the entire image curved surface, the information is used. In this case, the image information including the degree of shading is composed of plural pixel. As shown in FIG. 2D, each pixel 28 is represented by three-dimensional space. That is, each pixel 28 has three pieces of information, which are the pixel positions x and y, and the degree of shading z. Further, in the three-dimensional space, geometric curved surface is represented by the plural pixel 28. The geometric curved surface includes a curved surface represented on the three-dimensional space by a whole series of the plural pixel 28 which are obtained based on one shading pattern portion of the position measuring target 1, and the three-dimensional space is denoted by the pixel positions x and y, and the degree of shading z. The geometric curved surface includes at least one reference point.

The description will be followed with reference back to FIGS. 2A to 2D. In FIG. 2C, a plurality of black circles represent pixels 28 of the picked up image, and each pixel 28 is represented by three-dimensional coordinates of the pixel positions x and y and the degree of shading z. The planar surface 25 acquired from the picked up image is acquired based on three-dimensional positional information on each pixel 28. For example, the calculation of the reference points a1, b1, c1, and d1 can be performed as described below. However, the method of calculation of the reference points is not limited thereto, and a different method may be used. Now, the planar surface 25 will be focused. The equation of the planar surface is ax+by+cz=1, wherein a, b, and c are coefficients. The coefficients of the equation of the planar surface are determined by using the pixel position (xi, yi) and the degree of shading of each pixel of an image that belongs to the planar surface.

axi+byi+czi=1

Here, in a case where image data of i=1 to N is used, [a b c]·Mi=1.

$$Mi = ( \begin{matrix}x 1 & x 2 & x 3 & … & xi \\ y 1 & y 2 & y 3 & … & yi \\ z 1 & z 2 & z 3 & … & zi\end{matrix} ) \qquad [ Numeric Expression 1 ]$$

[a b c]·Mi·Mi⁻¹=1·Mi⁻¹ (Mi⁻¹ is an inverse matrix of Mi)

### [a b c]=Mi⁻¹

Accordingly, the coefficients a, b, and c can be calculated by using a least squares method. Then, an intersection line 27 of the planar surface 25 acquired here and the planar surface 26 of the object 5 is acquired. The intersection line is calculated by setting points at which the intersection lines 27 cross as the reference points a1, b1, c1, and d1 for position measurement. This is an example of calculation of a planar surface. However, a curved surface such as a sphere surface can be calculated similarly. Then, the three-dimensional position or the angle of the target is calculated based on the calculated reference points. This calculation method will be described later.

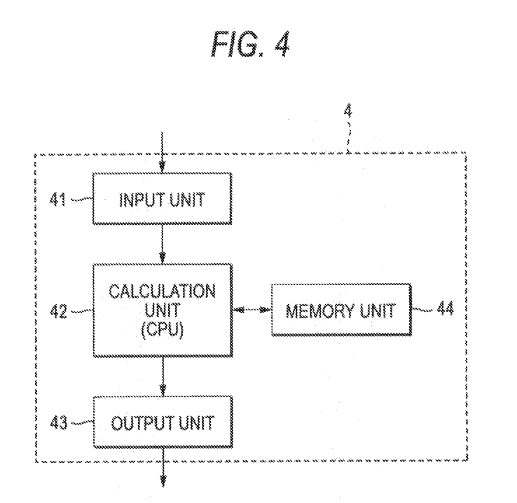

FIG. 4 is a block diagram representing a configuration example of the calculation device shown in FIG. 1. The calculation device 4 includes: an input unit 41 to which an image of the position measuring target 1 picked up by the image pickup device 3 having the two-dimensional image pickup element 2 is input; a calculation unit (CPU) 42 that calculates four or more reference points for position measurement based on the input image and acquires at least one of the three-dimensional position or the angle of the position measuring target 1 based on the calculated reference points; and an output unit 43 that outputs to a display device, such as a monitor, at least one of the three-dimensional position and the angle of the position measuring target 1, which has been calculated.

To the calculation unit 42, a memory unit 44 is connected. Thus, information is transmitted and received between the calculation unit 42 and the memory unit 44. In the memory unit 44, a table, in which the positional information of four reference points a1, b1, c1, and d1 is stored, is prepared. The calculation unit 42 acquires the stored positional information of the reference points from the memory unit 44 and calculates at least one of the three-dimensional position and the angle of the target based on the reference points that are calculated based on the picked up image. In addition, the memory unit 44 stores a program that is executed in the calculation unit 42 or various types of information used therein and can be configured as an internal memory. However, the memory unit 44 is not limited thereto and may be an externally connected memory device.

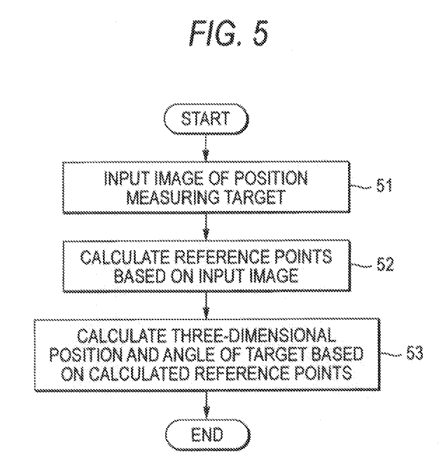

The above-described process can be performed by allowing a computer to execute the following program. FIG. 5 is a flowchart representing an example of the processes that are performed by the computer. In other words, this program performs processes of the Step 51, Step 52 and Step 53 to the computer. In the Step 51, the process is performed to input an image of the position measuring target 1 which is picked up by the imaging device 3 having the two-dimensional image pickup element 2. Specifically, the process is performed to obtain coordinates of the plural pixel including the plural shading pattern portion of the position measuring target 1. Each pixel has coordinate information which are the pixel position x and y, and the degree of shading z. In the Step 52, the process is performed to calculate four or more reference points for position measurement based on the input image. In the Step 53, the process is performed to acquire at least one of the three-dimensional position and the angle of the position measuring target 1 based on the calculated reference points. Each shading pattern portion corresponds to the geometric curved surface. In this example, an embodiment in which the program is stored in the memory unit of the calculation device has been described. However, the program can be provided by being stored on a storage medium such as a CDROM or can be provided by the communication means. Hereinafter, an example of the method of calculating the three-dimensional position of the target will be described.

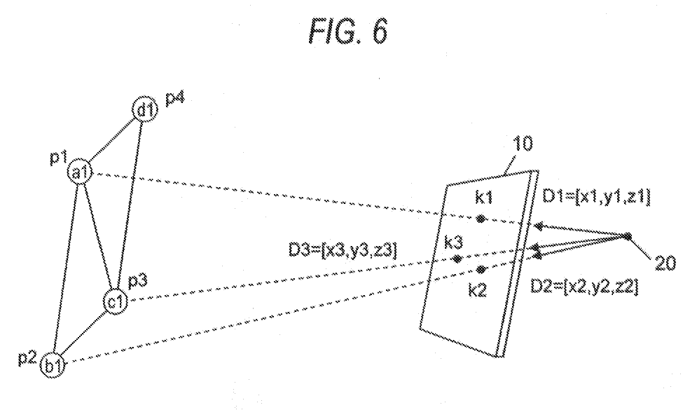

FIG. 6 is a diagram illustrating an example of a method of calculating a three-dimensional position of an object that has four reference points. In this example, the four reference points are defined, for example, as square angles, and two combinations of three reference points out of the four reference points will be considered. Then, two solutions are derived based on the following calculation by using three points, respectively. In one of the two solutions, the reference points represent the same values, and thus the solution is regarded as a correct solution. Accordingly, the position and the angle of the target can be determined.

First, as represented in FIG. 6, direction vectors Di (i=1, 2, or 3) of the positions of the reference points in a camera coordinate system are calculated based on the relationship between the positions k1, k2, and k3 of the image on the image surface 10 (the two-dimensional image pickup surface of the camera) of the reference points a1, b1, and c1 and the optical center 20 of the camera. Here, Di is a normalized unit vector.

When the spatial position vectors of the reference points a1, b1, and c1 are p1, p2, and p3, the position vectors exist on extended lines of Di. Thus, the position vectors can be represented as in Numeric Expression 2-1 by using coefficients of t1, t2, and t3.

$$\begin{matrix}[ Numeric Expression 2 \text{-} 1 ] & \\ \begin{matrix}p 1 = t 1 \cdot D 1 \\ p 2 = t 2 \cdot D 2 \\ p 3 = t 3 \cdot D 3\end{matrix} \} & ( 1 \text{-} 2 )\end{matrix}$$

The shapes of the triangles are known in advance. Thus, when the lengths are assumed to be as represented in Numeric Expression 2-2, the following equations are acquired.

$$\begin{matrix}[ Numeric Expression 2 \text{-} 2 ] & \\ \begin{matrix}p 1 p 2 = L 1 \\ p 2 p 3 = L 2 \\ p 3 p 1 = L 3\end{matrix} \} & ( 2 \text{-} 2 )\end{matrix}$$

In the following equations, sign “̂” denotes power.

$$\begin{matrix} [ Numeric Expression 2 \text{-} 3 ] & \\ \begin{matrix}{( t 1 x 1 - t 2 x 2 )}^{⋀} 2 + {( t 1 y 1 - t 2 y 2 )}^{⋀} 2 + {( t 1 z 1 - t 2 z 2 )}^{⋀} 2 = L {1}^{⋀} 2 \\ {( t 2 x 2 - t 3 x 3 )}^{⋀} 2 + {( t 2 y 2 - t 3 y 3 )}^{⋀} 2 + {( t 2 z 2 - t 3 z 3 )}^{⋀} 2 = L {2}^{⋀} 2 \\ {( t 3 x 3 - t 1 x 1 )}^{⋀} 2 + {( t 3 y 3 - t 1 y 1 )}^{⋀} 2 + {( t 3 z 3 - t 1 z 1 )}^{⋀} 2 = L {3}^{⋀} 2\end{matrix} \} & ( 2 \text{-} 3 )\end{matrix}$$

When being organized, Numeric Expression 2-4 is acquired.

$$\begin{matrix}[ Numeric Expression 2 \text{-} 4 ] & \\ \begin{matrix}t {1}^{⋀} 2 - 2 t 1 t 2 ( x 1 x 2 + y 1 y 2 + z 1 z 2 ) + t {2}^{⋀} 2 - L {1}^{⋀} 2 = 0 \\ t {2}^{⋀} 2 - 2 t 2 t 3 ( x 2 x 3 + y 2 y 3 + z 2 z 3 ) + t {3}^{⋀} 2 - L {2}^{⋀} 2 = 0 \\ t {3}^{⋀} 2 - 2 t 3 t 1 ( x 3 x 1 + y 3 y 1 + z 3 z 1 ) + t {1}^{⋀} 2 - L {3}^{⋀} 2 = 0\end{matrix} \} & ( 2 \text{-} 4 )\end{matrix}$$

Thus, the following equations are formed, wherein sign “sqrt” denotes a square root.

$$\begin{matrix}[ Numeric Expression 2 \text{-} 5 ] & \\ \begin{matrix}t 1 = A 1 \cdot t 2 \pm sqrt ( ( A {1}^{⋀} 2 - 1 ) \cdot t {2}^{⋀} 2 + L {1}^{⋀} 2 ) \\ t 2 = A 2 \cdot t 3 \pm sqrt ( ( A {2}^{⋀} 2 - 1 ) \cdot t {3}^{⋀} 2 + L {2}^{⋀} 2 ) \\ t 3 = A 3 \cdot t 1 \pm sqrt ( ( A {3}^{⋀} 2 - 1 ) \cdot t {1}^{⋀} 2 + L {3}^{⋀} 2 )\end{matrix} \} & ( 2 \text{-} 5 )\end{matrix}$$

Accordingly, A1, A2, and A3 are as the following equations.

$$\begin{matrix}[ Numeric Expression 2 \text{-} 6 ] & \\ \begin{matrix}A 1 = x 1 x 2 + y 1 y 2 + z 1 z 2 \\ A 2 = x 2 x 3 + y 2 y 3 + z 2 z 3 \\ A 3 = x 3 x 1 + y 3 y 1 + z 3 z 1\end{matrix} \} & ( 2 \text{-} 6 )\end{matrix}$$

There are real roots, and thus the inside of the square root represented in Numeric Expression 2-5 becomes positive.

$$\begin{matrix}[ Numeric Expression 2 \text{-} 7 ] & \\ \begin{matrix}t 1 \leq sqrt ( L {3}^{⋀} 2 / ( 1 - A {3}^{⋀} 2 ) ) \\ t 2 \leq sqrt ( L {1}^{⋀} 2 / ( 1 - A {1}^{⋀} 2 ) ) \\ t 3 \leq sqrt ( L {2}^{⋀} 2 / ( 1 - A {2}^{⋀} 2 ) )\end{matrix} \} & ( 2 \text{-} 7 )\end{matrix}$$

By sequentially substituting real numbers t1, t2, and t3 that satisfy these conditions in Numeric Expression 2-5, all t1, t2, and t3 that satisfy Numeric Expression 2-5 are calculated. Next, p1, p2, and p3, that is, the three-dimensional positions of the reference points are calculated from the above-described Numeric Expression 2-1. In a case where there are three reference points, one position has two solutions. However, there are four reference points in this example. Thus, the above-described calculation is performed for the other three reference points, for example, a1, b1, and d1, so that other two solutions are derived. In one solution of the two solutions, the positions of the reference points represent a same value, and thus the solution is regarded as a correct solution. Even in a case where there are four or more reference points, the above-described process is performed similarly. As described above, the three-dimensional position of the target can be determined. The angle of the target can be acquired as a direction in which the target faces from the three-dimensional position. The method of calculating the three-dimensional position of the target is not limited to the above-described method, and a different method may be used.

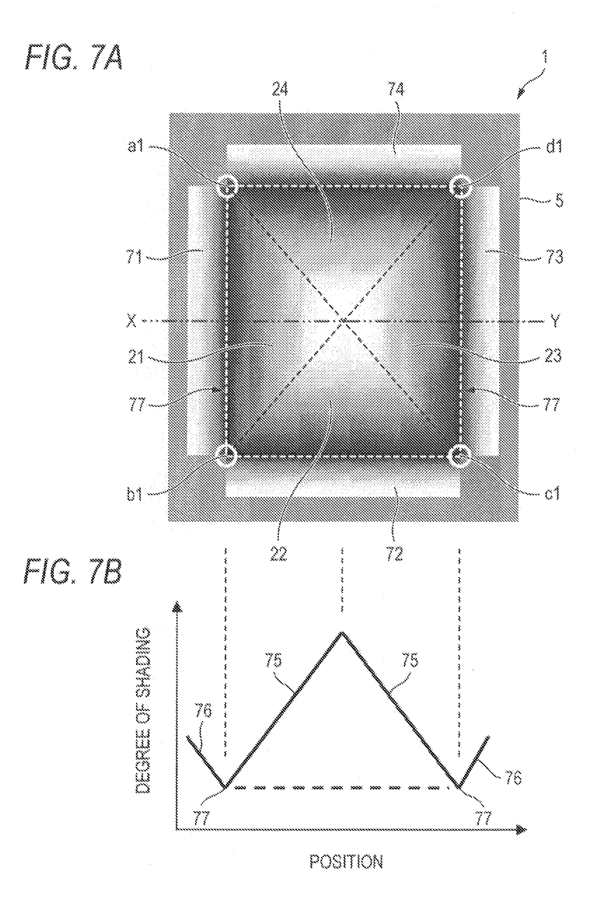

FIG. 7A is a diagram of a position measuring target according to another embodiment of the present invention. FIG. 7B is a diagram representing the degree of shading of a path denoted by X-Y shown in FIG. 7A. As represented in FIG. 7A, the position measuring target 1 of this example includes an object 5 having four or more reference points a1, b1, c1, and d1 of which the positional relationship defined on a plane is known and a plurality of shading pattern portions 21 to 24 that form a geometric curved surface in relation to the degree of shading used for defining the reference points. In this example, other shading pattern portions 71 to 74 that are adjacent to the shading pattern portions 21 to 24 and form a geometric curved surface in relation to the degree of shading are included. Accordingly, a plurality of intersection lines 77 are formed by the geometric curved surfaces 21 to 24 and the geometric curved surfaces 71 to 74 adjacent thereto, and the reference points a1, b1, c1, and d1 for position measurement are defined at points at which the intersection lines 77 cross each other. The three-dimensional position or the angle of the position measuring target 1 is calculated based on the reference points.

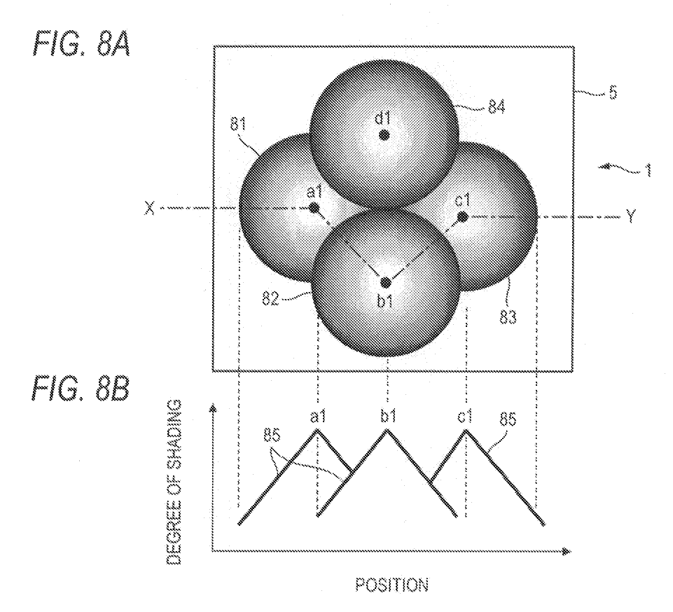

FIG. 8A is a diagram of a position measuring target according to another embodiment of the present invention. FIG. 8B is a diagram representing the degree of shading of a path denoted by X-Y shown in FIG. 8A. As represented in FIG. 8A, the position measuring target 1 of this example includes an object 5 having four or more reference points a1, b1, c1, and d1 of which the positional relationship defined on a plane is known and a plurality of shading pattern portions 81 to 84 that form a geometric curved surface in relation to the degree of shading used for defining the reference points. In this example, the geometric curved surface that is formed by the shading pattern portions 81 and 84 is, as represented in FIG. 8B, a conic surface 85. The reference points a1, b1, c1, and d1 are defined as vertexes of the conic surface 85. The three-dimensional position or the angle of the position measuring target 1 is calculated based on the reference points.

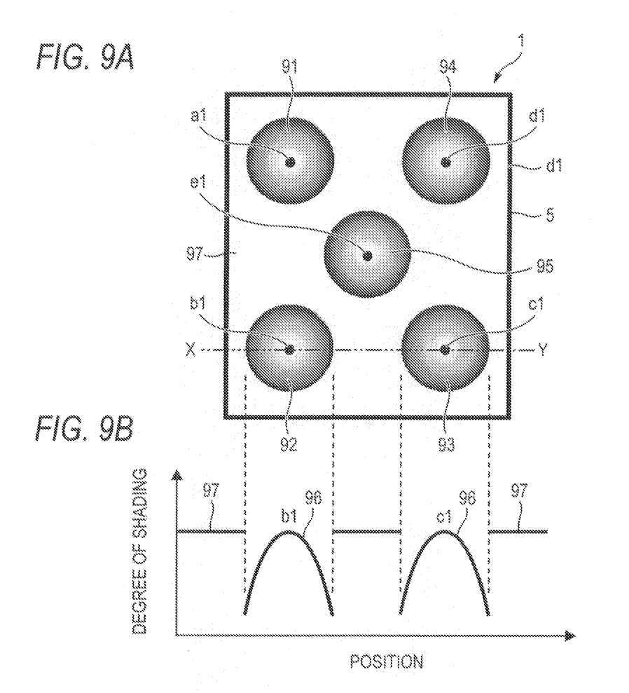

FIG. 9A is a diagram of a position measuring target according to another embodiment of the present invention. FIG. 9B is a diagram representing the degree of shading of a path denoted by X-Y shown in FIG. 9A. As represented in FIG. 9A, the position measuring target 1 of this example includes an object 5 having four or more reference points a1, b1, c1, d1, and e1 of which the positional relationship defined on a plane is known and a plurality of shading pattern portions 91 to 95 that form a geometric curved surface in relation to the degree of shading used for defining the reference points. In this example, the geometric curved surface that is formed by the shading pattern portions 91 and 95 is, as represented in FIG. 9B, an ellipsoid of revolution 96. The reference points a1, b1, c1, d1, and e1 are defined as vertexes of the ellipsoid of revolution 96. The three-dimensional position or the angle of the position measuring target 1 is calculated based on the reference points. The planar surface 97 of the object 5 of this example has, as represented in FIG. 9B, the degree of shading that is the same as the vertex of the ellipsoid of revolution 96. In this example, the geometric curved surface of the shading pattern portions 91 to 95 is the ellipsoid of revolution 96. However, the geometric curved surface is not limited thereto and, for example, may be a spherical surface or the like.

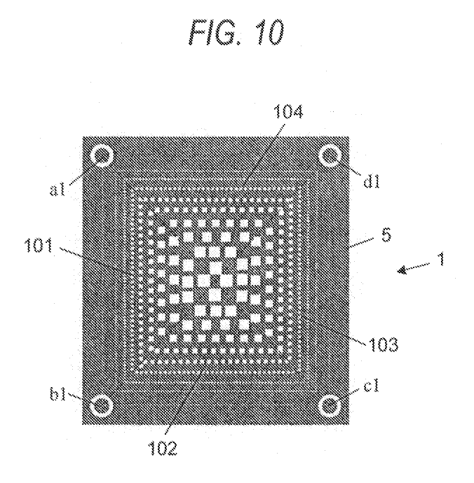

FIG. 10 is a diagram of a position measuring target according to another embodiment of the present invention. The position measuring target 1 of this example has a basic configuration that is the same as that represented in FIG. 2A. However, the shading pattern portions 101 to 104 are configured by using retroreflective members, which is different from that represented in FIG. 2A. The retroreflective member has a structure in which incident light is reflected back to the incident side. The retroreflective member, for example, may be a concave corner cube or the like. However, the retroreflective member is not limited thereto. In this example, the shading pattern portions 101 to 104 are formed based on the sizes and the density of disposition of a plurality of reflective elements (in the figure, rectangles in which only characters are represented to be white) configuring the retroreflective member. However, the shading pattern portions 101 to 104 are not limited thereto. Thus, the shading pattern portions 101 to 104 may be configured based on one of the size and the density of the disposition of the reflective elements. In this example, same as represented in FIG. 2B, the shading pattern portions 101 to 104 (the reflective elements are actually disposed to be more delicate with higher density than illustrated in the figure) form a planar surface in relation to the degree of shading. Accordingly, a plurality of intersection lines are formed by the planar surface of each shading pattern portion and the planar surface of the object 5, and reference points a1, b1, c1, and d1 for position measurement are defined at points at which the intersection lines cross each other. The three-dimensional position or the angle of the position measuring target 1 is calculated based on the reference points.

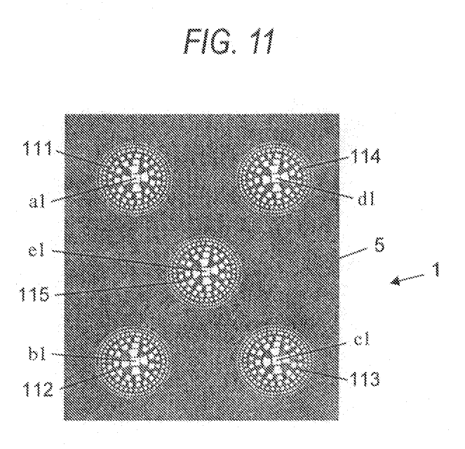

FIG. 11 is a diagram of a position measuring target according to another embodiment of the present invention. The position measuring target 1 of this example has a basic configuration that is the same as that represented in FIG. 9A. However, the shading pattern portions 111 to 115 are configured by using retroreflective members, which is different from that represented in FIG. 9A. In this example, the shading pattern portions 111 to 115 are formed based on the sizes and the density of disposition of a plurality of reflective elements (in the figure, rectangles in which only characters are represented to be white) configuring the retroreflective member. However, the shading pattern portions 111 to 115 are not limited thereto. Thus, the shading pattern portions 111 to 115 may be configured based on one of the size and the density of the disposition of the reflective elements. In this example, same as represented in FIG. 9B, the shading pattern portions 111 to 115 (the reflective elements are actually disposed to be more delicate with higher density than illustrated in the figure) forms an ellipsoid of revolution in relation to the degree of shading. The reference points a1, b1, c1, d1, and e1 are defined as vertexes of the ellipsoid of revolution. The three-dimensional position or the angle of the position measuring target 1 is calculated based on the reference points.

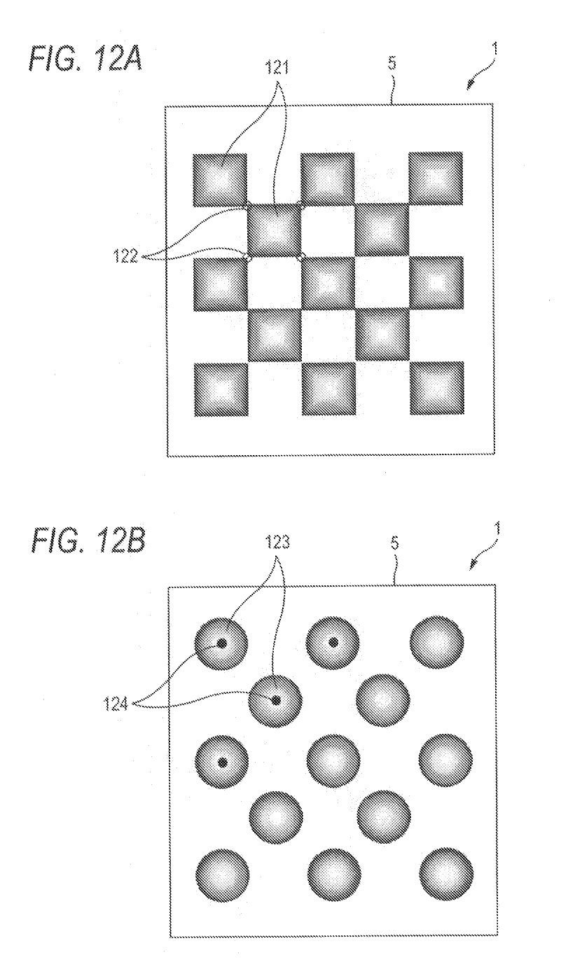

FIGS. 12A and 12B are diagrams of position measuring targets according to other embodiments of the present invention. The position measuring target 1 of this example is used as a checker board that is used for correcting distortion of a camera lens. In the example represented in FIG. 12A, a plurality of shading pattern portions 121 are arranged on an object 5. The shading pattern portion 121 includes a plurality of shading pattern portions that form a planar surface in relation to the degree of shading as represented in the above-described FIG. 2A. In this example, similarly to the case represented in the above-described FIG. 2B, a plurality of intersection lines are formed by the planar surface of each shading pattern portion 121 and the planar surface of the object 5, and a plurality of reference points 122 are defined at points at which the intersection lines cross each other. By setting the positions of actual reference points 122 to be in correspondence with the positions of the reference points 122 of a picked up image, the distortion of the lens can be corrected. In the example represented in FIG. 12B, a plurality of the shading pattern portions 123 are arranged on the object 5. The geometric curved surface that is formed by the shading pattern portion 123 is an ellipsoid of revolution as represented in the above-described FIG. 9A. The reference points 124 are defined as the vertexes of the ellipsoid of revolution. By setting the positions of actual reference points 124 to be in correspondence with the positions of the reference points 124 of the picked up image, the distortion of the lens can be corrected. By disposing the shading pattern portions 121 and 123 with a precision higher than that illustrated in the figure, the advantage of correction for the distortion of the lens is improved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A position measuring target comprising:
four or more reference points defined on a plane, the references points have positional relationships among them; and
a plurality of shading pattern portions that corresponds a plurality of geometric curved surfaces in relation to the degree of shading used for defining the reference points.

2. The position measuring target according to claim 1,
wherein the geometric curved surface indicates a curved surface represented on a three-dimensional space by a whole series of a plurality of pixels being obtained based on one shading pattern portion of the position measuring target.

3. The position measuring target according to claim 1,
wherein the reference points are defined at points at which intersection lines formed by each of the plurality of the geometric curved surfaces and the plane cross each other.

4. The position measuring target according to claim 1,
wherein first one of the plurality of shading pattern portions is adjacent to second one of the plurality of shading pattern portions, and
one of the reference points as point at which intersection lines formed by two geometric curved surfaces corresponding to the first and second ones of the plurality of shading pattern portions cross each other.

5. The position measuring target according to claim 1,
wherein the reference points are defined as vertexes of each of the plurality of the geometric curved surfaces.

6. The position measuring target according to claim 1,
wherein the plurality of the shading pattern portions has a retroreflective characteristic.

7. The position measuring target according to claim 6,
wherein the plurality of shading pattern portions has reflective elements having the retroreflective characteristic and difference sizes.

8. The position measuring target according to claim 6, wherein the plurality of shading pattern portions has reflective elements having the retroreflective characteristic and difference density of disposition.

9. A position measurement system comprising:
a position measuring target including
four or more reference points defined on a plane, the references points have positional relationships among them, and
a plurality of shading pattern portions that correspond a plurality of geometric curved surfaces in relation to the degree of shading used for defining the reference points;
an image pickup device that has a two-dimensional image pickup element picking up an image of the position measuring target; and
a calculation device that calculates the four or more reference points based on the image of the position measuring target being picked up by the image pickup device and that acquires at least one of a three-dimensional position and an angle of the position measuring target based on the calculated reference points.

10. The position measurement system according to claim 9,
wherein the geometric curved surface indicates a curved surface represented on the three-dimensional space by a whole series of the plurality of pixels being obtained based on one shading pattern portion of the position measuring target.

11. The position measurement system according to claim 9,
wherein the reference points are defined at points at which intersection lines formed by each of the plurality of the geometric curved surfaces and the plane cross each other.

12. The position measurement system according to claim 9,
wherein first one of the plurality of shading pattern portions is adjacent to second one of the plurality of shading pattern portions, and
one of the reference points as point at which intersection lines formed by two geometric curved surfaces corresponding to the first and second ones of the plurality of shading pattern portions cross each other.

13. The position measurement system according to claim 9,
wherein the reference points are defined as vertexes of each of the plurality of the geometric curved surfaces.

14. The position measurement system according to claim 9,
wherein the plurality of the shading pattern portions has a retroreflective characteristic.

15. The position measurement system according to claim 14,
wherein the plurality of shading pattern portions has reflective elements having the retroreflective characteristic and difference sizes.

16. The position measurement system according to claim 14,
wherein the plurality of shading pattern portions has reflective elements having the retroreflective characteristic and difference density of disposition.

17. A calculation device for position measurement, the calculation device comprising:
inputting an image of a position measuring target, which the image is picked up by an image pickup device having a two-dimensional image pickup element, the position measuring target including
four or more reference points defined on a plane, the references points have positional relationships among them, and
a plurality of shading pattern portions that correspond a plurality of geometric curved surfaces in relation to the degree of shading used for defining the reference points;
calculating the four or more reference points based on the input image; and
acquiring at least one of a three-dimensional position and an angle of the position measuring target based on the calculated reference points.

18. A computer readable medium storing a program causing a computer to execute a measurement process, the management process comprising:
inputting an image of a position measuring target, which the image is picked up by an image pickup device having a two-dimensional image pickup element; the position measuring target including
four or more reference points defined on a plane, the references points have positional relationships among them, and
a plurality of shading pattern portions that correspond a plurality of geometric curved surfaces in relation to the degree of shading used for defining the reference points;
calculating the four or more reference points based on the input image; and
acquiring at least one of a three-dimensional position and an angle of the position measuring target based on the calculated reference points.
